(19) United States
(12) Patent Application Publication
(10) Pub. No.: US 2014/0198510 A1
(43) Pub. Date: Jul. 17, 2014

(54) Methods And Systems For Truck Bed LED Light Strip With LED Flashlights

(71) Applicants: Calvin Chuen Kam Law, Chino, CA (US); George Lee, Brea, CA (US)

(72) Inventors: Calvin Chuen Kam Law, Chino, CA (US); George Lee, Brea, CA (US)

(21) Appl. No.: 13/743,272

(22) Filed: Jan. 16, 2013

(51) Int. Cl. B60Q 1/00

(52) U.S. Cl. CPC B60Q 1/00
USPC 362/485

(57) ABSTRACT

A modular in-bed lighting system with detachable flashlights for use with trucks having an open bed or one covered by a shell. The support member mounted on the side walls of the truck and across the front wall of the bed such that the lights are below the top surface of the side walls. In this way the lights are positioned to illuminate the open or covered bed while not shining above the top of the sidewalls or closed tail gate.

### FIELD OF THE INVENTION

The present invention relates to vehicle lighting system and more particularly to an improved lighting system for installation and use in open back sports and utility trucks. Specifically, the present invention relates to a truck bed rail lighting system with an internal light source and light transmitting apertures, as well as flashlight that may be detached from the side of the light bar.

### BACKGROUND OF THE INVENTION

In recent years there has been an increased use of trucks as a mode of personal transportation in contrast to sedan type vehicles. In part, the increase is due to the desire for a vehicle that is somewhat mere versatile than a sedan in that it allows one to carry cargo and tends to be more utilitarian than a sedan. In fact, trucks are used for more than hauling large or heavy loads. Truck owners view their trucks as a personal statement i.e., a reflection of their attitude, style, and personality. Truck owners appreciate the functional utility and versatility that trucks can offer over the more prevalent sedans. The use of trucks has become so popular that many of the truck owners have spent considerable sums improving the appearance of their vehicles and personalizing the functionality and appearance of their trucks by adding to the vehicle items not offered by the original manufacturer.

While there are many important benefits to owning a truck, there are a few shortcomings. For example, while the interior of a sedan or minivan can easily be illuminated by an overhead lighting system, this is not possible in an open truck bed. Although trucks generally have an overhead light mounted within the cab itself, this light is not sufficiently bright or properly directed to adequately illuminate the truck bed. While exterior lights are sometimes mounted rearward on rollover bars or on the top or rear of the truck cab, these lights cannot be used to illuminate the truck bed while the vehicle is being driven down a road, as these lights will temporarily blind drivers behind the truck. In some states, even if the lights are facing the front of the truck, the lights above the cab must have a cover to prevent them from accidentally temporarily blinding other drivers.

Also, the customization of trucks and truck ownership has increased substantially in recent years. Although trucks have an obvious utility for carrying loads, they are also becoming very popular to personalize and reflect the personality of the driver. Truck owners continually look for ways to personalize the appearance of their vehicles but also add function and safety. Consumers can also attach the light bar between the tailgate and bumper as a stylish aftermarket makeover for their truck. Auto enthusiasts often seek new ways to distinguish their vehicle from the stock model by accessorizing the exterior of their vehicle with aftermarket parts including but not limited to light bulbs, light covers, rims, and body kits.

One common truck accessory is a so-called “bed rail”, an accessory that is often formed of tubular enclosure, or the like, and bolted to the upper surfaces on either side of the truck's bed. Generally speaking, the prior art bed rails have been formed from single, solid walled tube that is bolted to the truck bed with a suitable flange. The general goal is structural integrity since fairly heavy loads may be applied to the bed rails.

While mounting lights on the cab of the truck may be helpful and better than having no lights, they are not really effective in properly illuminating the entire truck bed without temporarily blinding someone approaching the truck bed from the rear. Further, they do not eliminate the need for the owner to use a flashlight when rummaging about the back bed, because of the shadows and uneven lighting conditions which result when taller objects are properly positioned closer to the cab of the truck thereby blocking the lights from illuminating shorter objects closer to the tailgate of the truck. Still further, such additional equipment is bulky and significantly affects the look and aerodynamics of the vehicle.

With the innovations of LED technology that have brought down the manufacturing cost with increased functionality, automotive owners now have new ways to personalize their vehicles while increasing safety. The use of LED Lights to illuminate the bed of the vehicle is desirable because LEDs lights up with a faster response time than traditional incandescent bulbs. As such, LED-based lighting is becoming very popular for a variety of reasons: light-emitting diodes are small, completely solid state, very power-efficient, and have very long lives having no filaments to burn out.

An attempt to address these shortcomings was presented in U.S. Pat. No. 5,795,051 of Galanski. The '051 patent discloses a rearward facing lighting system designed to be mounted between the side walls of the truck bed against the front wall of the bed near the rear wall of the cab of the truck. The rearward facing lighting system of the '051 patent is oriented such that the top wall of the lighting system support is positioned generally level with the top of the side walls of the truck bed such that the rearward facing light assemblies are positioned below the top of the bed of the truck. In this manner, the truck bed may be illuminated even if a bed cover is installed. While the invention of the '051 patent alleviates some of the problems associated with traditional truck bed lighting systems, it does not adequately address the problems associated with having rearward facing lights mounted on a truck. Nor does it address or reduce the problems associated with uneven distribution of light along the length of the truck bed. Actually, because the lighting system of the '051 patent is mounted below the level of more traditional lighting systems, it actually accentuates many of the problems associated with uneven and inadequate lighting of the truck bed, as it creates even greater potential for shadows and spaces in the truck bed not being illuminated. Further, the truck lighting system of the '051 patent requires the installation of a mounting system, which reduces the functionality of the truck bed by blocking valuable space in the back of the truck bed closest to the cab. Still further, the truck owner may wish instead to install a tool box or other functional accessory which is generally mounted closest to the truck cab. Still further, because these lights are exposed to the interior of the truck bed, they can easily be damaged by weather or by inadvertent contact of object stored in the truck bed. Also, because the truck lighting system of the '051 patent faces rearward and shines light in the direction of drivers behind the truck, it requires that a tailgate of a truck be in the closed position when the lights are illuminated to prevent the temporary blinding of drivers behind the vehicle.

What is needed is a truck lighting system which can accomplish one or more of the following: (i) effectively illuminate the entire length of the truck bed without temporarily blinding drivers behind the vehicle or those positioned at the tailgate of the truck even when the tailgate is removed; (ii) be protected from accidental damage due to contact with objects contained within the truck bed or due to damage from weather; (iii) will not impede the use of the entire space of the truck bed nor distract from the intended aesthetic design of the truck; (iv) can be easily installed either in the factory or after market without modification to the design of the truck; and (v) equipped conveniently with flashlight lights that can be detached from the light bar.

The present invention provides for a light bar that accomplishes the above and also provides additional, improved functionality.

### OBJECT OF THE INVENTION

Accordingly, it is an object of this invention to provide a method and system for a truck bed rail lighting system with a light bar and flashlight that may be detached from the sides of the light bar.

It is also an object of this invention to provide a truck bed lighting system which illuminates the entire bed of a truck.

It is also an object of this invention to provide a truck bed lighting system which is relatively inexpensive.

It is also an object of this invention to provide a truck bed lighting system that does not require extensive modification to the design of the truck.

It is also an object of this invention to provide a truck bed lighting system that is simple to install both in the factory and as an after-market accessory.

It is also an object of this invention to provide a truck bed lighting system that effectively illuminates the entire length of the truck bed without temporarily blinding drivers behind the vehicle or those positioned at the tailgate of the truck even when the tailgate is removed.

It is also an object of this invention to provide a truck bed lighting system that is protected from accidental damage due to contact with objects contained within the truck bed or due to damage from weather.

It is also an object of this invention to provide a truck bed lighting system that will not impede the use of the entire space of the truck bed nor distract from the intended aesthetic design of the truck.

It is also an object of this invention to provide a truck bed lighting system that can be electrically connected to the truck via a standard adaptor or connected to the existing wires in the truck that provides electricity to power the lighting system.

It is also an object of this invention to provide a truck bed lighting system that is equipped conveniently with one or more flashlight that can be attached and detached from the light bar from one or both ends.

It is also an object of this invention to provide a truck bed lighting system comprising a light bar and at least one detachable flashlight, wherein the flashlight can be powered by its own internal batteries.

It is also an object of this invention to provide a truck bed lighting system comprising a light bar and at least one detachable flashlight, wherein the light bar charges the batteries of the flashlight.

### SUMMARY OF THE INVENTION

Presently disclosed is a lighting apparatus suitable for mounting to a truck bed of a vehicle having a primary unit and at least one detachable unit wherein the primary unit and aid detachable unit are comprised of at least one light unit for illumination wherein the detachable unit is attached to the primary unit and is detachable from the primary unit to function as a handheld flashlight unit wherein the detachable light unit is further comprised of at least one battery unit to hold electrical charge to power the detachable unit when the detachable unit is detached from the primary unit.

In one embodiment, the primary unit charges the detachable unit's battery when the detachable unit is attached to say primary unit. In one embodiment, the light unit of the detachable unit draws electric power from the battery of the detachable unit when the detachable unit is attached to the primary unit. In one embodiment, the light unit is a LED light. In one embodiment, the primary unit draws electrical power from the vehicle. In one embodiment, the primary unit is further comprised of a electrical charger is capable of charging the battery of the detachable unit when the detachable unit is attached to the primary unit.

In one embodiment, the detachable unit is further comprised of a handle suitable for hand holding when detached from the primary unit. In one embodiment, the detachable unit is further comprised of more than one light unit in at least two of the surfaces of the detachable unit.

In another aspect of the invention, a method to provide a light unit suitable for mounting to a truck is disclosed comprising a. providing a lighting apparatus suitable for mounting to a truck bed of a vehicle having a primary unit and at least one detachable unit wherein the primary unit and aid detachable unit are comprised of at least one light unit for illumination wherein the detachable unit is attached to the primary unit and is detachable from the primary unit to function as a handheld flashlight unit wherein the detachable light unit is further comprised of at least one battery unit to hold electrical charge to power the detachable unit when the detachable unit is detached from the primary unit, b. mounting the lighting apparatus to the truck bed. In one embodiment, the primary unit charges the detachable unit's battery when the detachable unit is attached to say primary unit. In one embodiment, the light unit of the detachable unit draws electric power from the battery of the detachable unit when the detachable unit is attached to the primary unit. In one embodiment, the light unit is a LED light.

In one embodiment, the primary unit draws electrical power from the vehicle. In one embodiment, the primary unit is further comprised of a electrical charger is capable of charging the battery of the detachable unit when the detachable unit is attached to the primary unit. In one embodiment, the detachable unit is further comprised of a handle suitable for hand holding when detached from the primary unit. In one embodiment, the detachable unit is further comprised of more than one light unit in at least two of the surfaces of the detachable unit. In one embodiment, the lighting unit is further comprised of more than attachment mechanism for mounting the lighting apparatus to the truck bed. In one embodiment, the lighting unit is waterproof. In one embodiment, the lighting unit uses silicon gel to seal the lighting unit so the lighting unit is waterproof.

### BRIEF DESCRIPTIONS OF THE DRAWINGS

These and other features and advantages of the invention will not be described with reference to the drawings of certain preferred embodiments, which are intended to illustrate and not to limit the invention, and in which:

FIGS. 1a and 1b are schematic drawings illustrating embodiments of the lighting system with one detachable flashlight each attached to the ends of the light bar installed on the front of the truck bed.

FIG. 2 is a schematic drawing illustrating an embodiment of the lighting system that is comprised of a light bar with one detachable flashlight each attached to the ends of the light bar.

FIG. 3 is a schematic drawing illustrating of an embodiment of the lighting system that is comprised of a light bar with one detachable flashlight each detached to the ends of the light bar.

FIG. 4 is a schematic drawing illustrating of an embodiment of the lighting system with one detachable flashlight each attached to one end of the light bar.

FIG. 5 is a schematic close-up drawing illustrating an embodiment of the lighting system that is comprised of a light bar with one detachable flashlight detached from the end of the light bar.

FIG. 6 is a schematic drawing illustrating of an embodiment of the flashlight detached from the lighting system.

### DETAIL DESCRIPTIONS OF THE INVENTION

In accordance with this invention, an improved and relatively simple lighting system for trucks in provided which is relatively simple to install, effective in illuminating the truck bed, and attractive in appearance.

The lighting system of this invention, which may be original equipment or installed as an after market item and integrated into the front bed panel, generally includes a support member that is located in the portion of the bed to the rear of the truck or what amounts to the front of the bed. Normally, a truck bed for sports and utility trucks includes a floor or bottom wall, a front wall to the rear of the cab, side walls and a tail gate moveable from a closed to a down position. The lighting system of this invention is preferably supported against the front wall of the bed or even by the side walls of the truck bed.

The orientation of the lighting system is such that the top wall of the support member is positioned so as to be level with the top of the side or the front wall of the truck bed. By locating the lighting support member as described, it is assured that the light system is vertically below the top of the side and front wall as well as the top of the tail gate. The advantage of positioning and orienting the lighting system is at least twofold. The first advantage is a functional: in this fashion, the lights themselves do not extend above the walls of the truck bed and will not distract or “blind” a trailing vehicle, provided the tail gate is in the up position. Furthermore, the lights easily illuminate the entire truck bed, yet they are not annoying in the sense that they illuminate regions above the cab, as is the case with lights mounted on structural or decorative roll over bars. Another advantage is aesthetics: the lighting system being leveled with the top of the side or the front wall of the truck bed assures that it looks integrated with the truck. Furthermore, because the lights do not extend above the walls of the truck bed.

The lighting system can be mounted to the truck in various positions and orientations described above via several methods. In one embodiment, the support member extends between the side walls of the bed and is secured thereto as will be described. In another embodiment, the support member includes an upper section which overlies the side walls of the truck bed as opposed to being supported between the side walls. Regardless of the details of mounting the lighting system, the mount is sufficiently strong, relatively easy to install, and is attractive.

It is understood that the actual dimensions of the lighting system may vary since the dimensions of truck beds may vary from model to model of truck depending on the manufacturer and style of truck. However, because of the relative simplicity of the structure of the lighting system, it is relatively easy to provide a unit which easily fits any particular truck model.

In a more particular aspect, at least one detachable flashlight unit is attached to one end of the light bar. In another embodiment, one detachable flashlight each can be attached to both ends of the light bar. The detachable flashlight at the ends of the light bar attaches onto the light bar itself to form a complete lighting system. Together with the flashlight attached, the light bar functions to illuminate the truck bed as described. Alternatively, the flashlight can also be detached from the light bar for use as necessary. Detaching the flashlight will not affect the functionality of the light bar itself. As such, the flashlight and the light bar can both be used simultaneously or individually as required.

The flashlight will be battery powered. In one embodiment, the flashlight can use proprietary rechargeable batteries. The flashlight can be recharged by reattaching them back to the light bar unit, wherein the light bar which draws electricity from the automobile charges the flashlight. In another embodiment, the flashlight can use standard rechargeable batteries, such as rechargeable AA batteries. The batteries can still be charged via reattaching the flashlight to the light bar, or the batteries can be taken out and replaced with regular AA batteries if necessary.

While the lighting system can use a variety of lighting or illuminating sources such as standard light bulbs or lamps, it is preferable that LEDs are used as the illuminating source. LEDs are preferred because they are small and are thus easier to integrate into a variety of designs, making them ideal in situations where aesthetics are of importance. LEDs are also completely solid state, and as such, they have no moving parts. This is important because automobiles creates a lot of vibration while being driven, therefore, auto accessories must be able to withstand such impacts. LEDs are also power-efficient, which makes them ideal for use in auto accessories since they draw their electricity from the battery of the car. Finally, LEDs have very long lives as they do not have filaments that can burn out. This allows the auto accessories to last longer without the need for much maintenance.

It will be apparent from the following description which should be read together with the accompanying drawings that there are other advantages of the present invention as is apparent from the disclosed preferred embodiments of the various forms of this invention and that the accompanying detailed description should be read as not limiting the present invention, but as explaining the same.

### DETAIL DESCRIPTIONS OF THE DRAWINGS

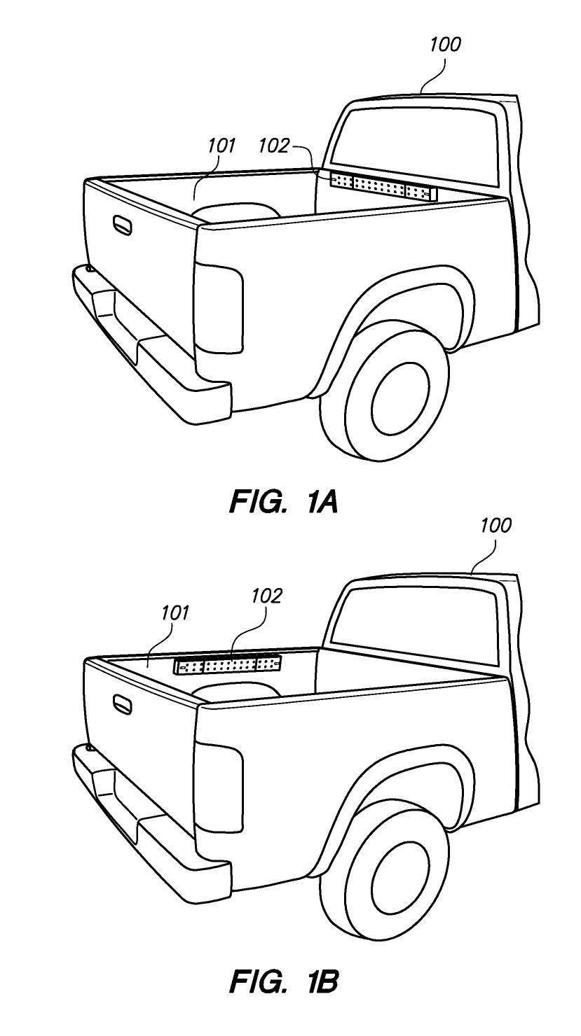

Referring to the drawings which illustrate preferred forms of the present invention, FIGS. 1a and 1b illustrate the embodiments of an overall scheme of an LED lighting system according to the disclosed invention. More specifically, the LED light bar 102 attaches to the truck 100 at the front of the truck bed 101, wherein the LED light bar 102 illuminates the truck bed 101 for ease of use when load or unloading from the truck bed 101. The LED light bar 102 can be mounted on the front of the truck bed 101 of a pickup truck or similar vehicle, wherein the LED light bar can provide the necessary illumination for the pickup truck or similar vehicle.

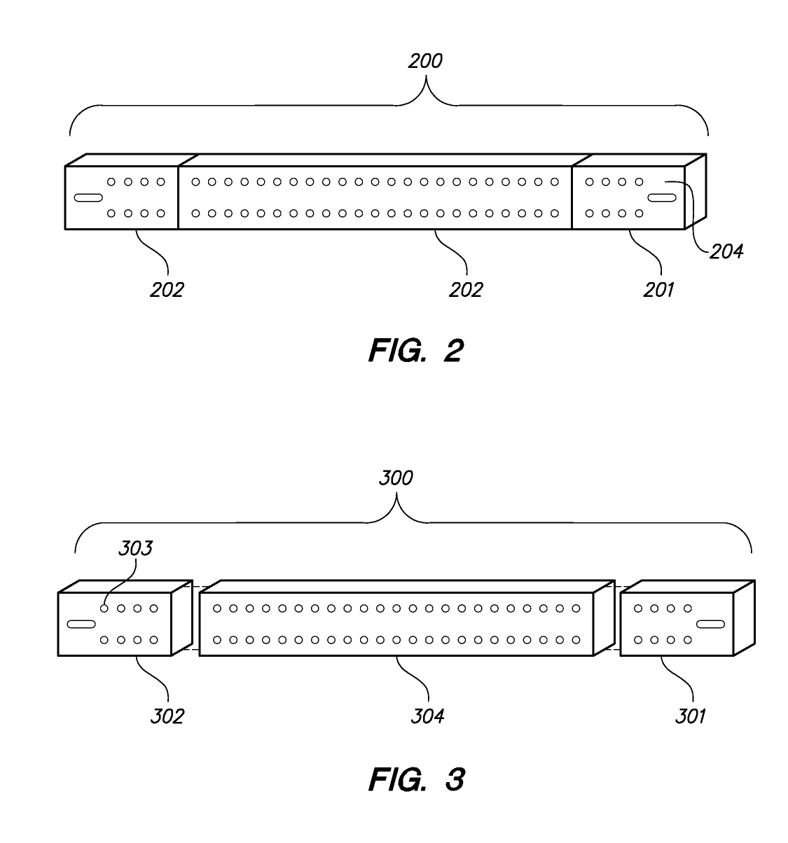

FIG. 2 illustrates an embodiment of the LED light bar 200 comprising of one detachable LED flashlight 201 that is attached on one end of the light bar 200, another detachable LED flashlight 202 that is attached on the other end of the light bar, and a main LED light bar 203 for illuminating the truck bed, wherein the circuit board along with the individual LEDs are secured in a housing 204.

FIG. 3 illustrates an embodiment of the LED light bar 300 separated into the main LED light 304, a right LED flashlight 301, and a left LED flashlight 302. The individual LEDs 303 in the LED flashlights 301, 302, and the main LED light bar 304 are secured in a housing, wherein the LED flashlights 301, 302 can be detached for use as a regular flashlight while the main LED light strip 304 continues to function as illumination source. The ends of the housing bar serve as a attaching apparatus for the LED flashlights 301, 302 that can be detached for use and reattached to the main LED light strip 304. Furthermore, the LED flashlights 301, 302 can either be charged via reattaching to the main LED light strip 304 or the LED flashlights 301, 302 can be powered via standard or rechargeable batteries.

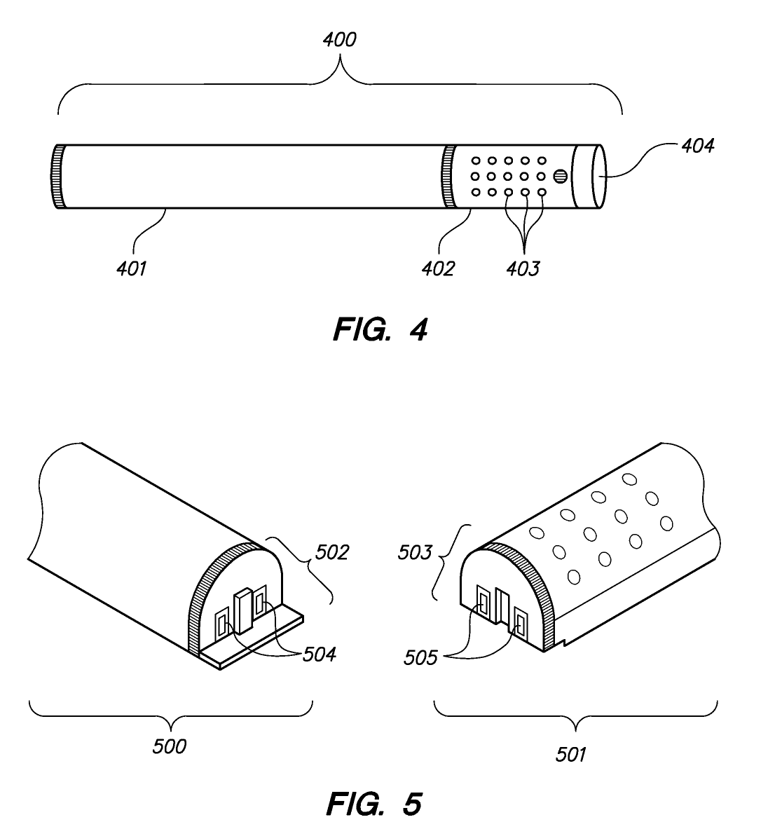

FIG. 4 illustrates an embodiment of the LED lighting system 400 comprised of a light bar 401 and a detachable flashlight 402 attached to the light bar 401 according to the disclosed invention. More specifically, the LED light bar 401 and the flashlight 402 can be separated from each other to be used separately and simultaneously, or they can be attached to each other. On the flashlight 402, there is a button for controlling the illumination of the flashlight 402 or for turning the flashlight 402 on or off. Furthermore, the flashlight 402 has two sets of LED lights—one set of LED lights 403 in the body of flashlight and another set of LED lights 404 at the end of the flashlight for providing illumination.

FIG. 5 illustrates an embodiment of the LED lighting system with the light bar 500 and the flashlight 501 detached from each other. Where the light bar 500 and the flashlight 501 attach and connect to each other, there are a securing mechanism 502, 503 and a charging mechanism 504, 505. The securing mechanism 502, 503 allows the flashlight 501 to be reattached to the light bar 500 securely and easily, while still allow the flashlight 501 to be easily detached from the light bar 500 when necessary. The charging mechanism 504, 505 is comprised of metal connectors 504, 505 on the end of the light bar 500 and on the end of the flashlight 501, wherein by connecting the flashlight 501 to the light bar 500 will allow the batteries in flashlight 501 to be charged through the light bar 500 via electricity drawn from the automobile.

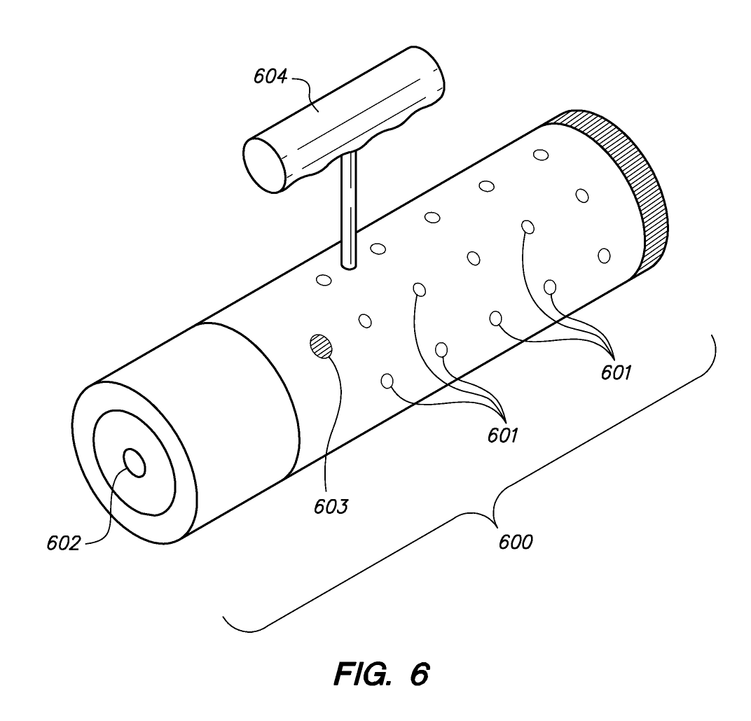

FIG. 6 illustrates an embodiment of the LED flashlight 600 only, as detached from the light bar of the lighting system. The LED flashlight 600 has two sets of LEDs—one set of LEDs in the body 601 of the flashlight 600 itself and another set of LEDs at the end 602. The LEDs in the body 601 of the flashlight provides a wider coverage of illumination, whereas the LEDs in the end 602 of the flashlight provides a more focused coverage of illumination. The button 603 on the flashlight serves to control the sets of LEDs 601, 602 for illumination, the intensity or type of illumination, and/or powering on or off the flashlight. Furthermore, there is also a handle mechanism 604 for the flashlight to be held by a user once it is detached from the light bar.

1. A lighting apparatus suitable for mounting to a truck bed of a vehicle having a primary unit and at least one detachable unit wherein said primary unit and aid detachable unit are comprised of at least one light unit for illumination wherein said detachable unit is attached to said primary unit and is detachable from said primary unit to function as a handheld flashlight unit wherein said detachable light unit is further comprised of at least one battery unit to hold electrical charge to power said detachable unit when said detachable unit is detached from said primary unit.

2. The apparatus of claim 1 wherein said primary unit charges said detachable unit's battery when said detachable unit is attached to say primary unit.

3. The apparatus of claim 1 wherein said light unit of said detachable unit draws electric power from said battery of said detachable unit when said detachable unit is attached to said primary unit.

4. The apparatus of claim 1 wherein said light unit is a LED light.

5. The apparatus of claim 1 wherein said primary unit draws electrical power from said vehicle.

6. The apparatus of claim 1 wherein said primary unit is further comprised of a electrical charger is capable of charging said battery of said detachable unit when said detachable unit is attached to said primary unit.

7. The apparatus of claim 1 wherein said detachable unit is further comprised of a handle suitable for hand holding when detached from said primary unit.

8. The apparatus of claim 1 wherein said detachable unit is further comprised of more than one light unit in at least two of the surfaces of said detachable unit.

9. A method to provide a light unit suitable for mounting to a truck comprising a. providing a lighting apparatus suitable for mounting to a truck bed of a vehicle having a primary unit and at least one detachable unit wherein said primary unit and aid detachable unit are comprised of at least one light unit for illumination wherein said detachable unit is attached to said primary unit and is detachable from said primary unit to function as a handheld flashlight unit wherein said detachable light unit is further comprised of at least one battery unit to hold electrical charge to power said detachable unit when said detachable unit is detached from said primary unit, b. mounting said lighting apparatus to said truck bed.

10. The method of claim 9 wherein said primary unit charges said detachable unit's battery when said detachable unit is attached to say primary unit.

11. The method of claim 9 wherein said light unit of said detachable unit draws electric power from said battery of said detachable unit when said detachable unit is attached to said primary unit.

12. The method of claim 9 wherein said light unit is a LED light.

13. The method of claim 9 wherein said primary unit draws electrical power from said vehicle.

14. The method of claim 9 wherein said primary unit is further comprised of a electrical charger is capable of charging said battery of said detachable unit when said detachable unit is attached to said primary unit.

15. The method of claim 9 wherein said detachable unit is further comprised of a handle suitable for hand holding when detached from said primary unit.

16. The method of claim 9 wherein said detachable unit is further comprised of more than one light unit in at least two of the surfaces of said detachable unit.

17. The apparatus of claim 1 wherein said lighting unit is further comprised of more than attachment mechanism for mounting said lighting apparatus to said truck bed.

18. The apparatus of claim 1 wherein said lighting unit is waterproof.

19. The apparatus of claim 1 wherein said lighting unit uses silicon gel to seal said lighting unit so said lighting unit is waterproof.
